(19) United States
(12) Patent Application Publication
(10) Pub. No.: US 2005/0185101 A1
(43) Pub. Date: Aug. 25, 2005

(54) Signal combination apparatus and communication system

(75) Inventors: Pi-Yao Chien, Taichung Hsien (TW); Shu-Wen Cheng, Hang-zhou (CN); Li Wan, Hang-zhou (CN); Dan Duan, Hang-zhou (CN); Bing Sheng, Hang-zhou (CN); Yue Pan, Hang-zhou (CN)

Correspondence Address: RADER FISHMAN & GRAUER PLLC, LION BUILDING, 1233 20TH STREET N.W., SUITE 501, WASHINGTON, DC, 20036, US

(73) Assignee: Asia Optical Co., Inc.

(21) Appl. No.: 11/038,051

(22) Filed: Jan. 21, 2005

(30) Foreign Application Priority Data
Feb. 19, 2004 (TW) 093104097

(51) Int. Cl. H04N 5/38; H04N 7/173; H04N 7/16

(52) U.S. Cl. 348/723; 725/115; 725/145; 725/117; 725/147

(57) ABSTRACT

A signal combination apparatus and a communication system for combining video signal, audio signal and data signal are provided. The present invention includes a modulator, a signal processor and an adder. The modulator modulates the video signal to generate a first signal. The signal processor encodes and modulates the audio signal and the data signal to generate a second signal. The adder makes addition operation of the first signal and the second signal to generate a transmission signal which is transmitted via an optic fiber.

### CROSS REFERENCE TO RELATED APPLICATIONS

This application claims priority to Taiwan Patent Application No. 093104097 entitled “Signal Combination Apparatus And Communication System”, filed on Feb. 19, 2004.

### FIELD OF THE INVENTION

The present invention generally relates to a signal combination apparatus and a communication system for combining video signal, audio signal and data signal.

### BACKGROUND OF THE INVENTION

Transmission and integration of information is an important issue which needs urgent solution. The information integration described herein includes integrating audio signal, video signal, and data signal. FIG. 1 illustrates a prior art communication system for combining the video signal and the audio signal. As shown in FIG. 1, the prior art communication system 11 receives and combines a video signal 100 with an audio signal 102, and transmits the combined signal to a receiver. And then the receiver recovers the two signals respectively. The intention for transmitting two different signals simultaneously may be achieved.

An image capture apparatus 12 (e.g., a digital video camera) is configured to capture image and then transmit the video signal 100 of the image to an adder 103 of the communication system 11. A voice receiving apparatus 13 (e.g. a microphone) is configured to transmit the audio signal 102 to a first modulators 101. The first modulator 101 is configured to modulate the audio signal 102 by a signal of a first frequency to generate a first modulated signal 104. The adder 103 makes addition operation of the first modulated signal 104 and the video signal 100 to generate a signal 106. The signal 106 is then transmitted to a second modulator 105 of the communication system 11. The second modulator 105 is configured to modulate the signal 106 by a signal of a second frequency to generate a transmission signal 108.

The transmission signal 108 is transmitted to the receiver of the communication system 11 by a coaxial cable. The receiver of the communication system 11 includes a first demodulator 107, a first band pass filter 109, a second band pass filter 113, a second demodulator 115, a first amplifier 111 and a second amplifier 117. The first demodulator 107 is configured to receive and then demodulate the transmission signal 108. The transmission signal 108 is demodulated into a video demodulated signal 110 which is transmitted to the first band pass filter 109, and a first audio demodulated signal 116 which is transmitted to the second band pass filter 113. The original video signal 100 and audio signal 102 are therefore recovered. The first band pass filter 109 is configured to generate a signal 112, and then transmit the signal 112 to the first amplifier 111 for compensating the signal loss during the transmission process. A recovered video signal 114 is therefore generated. The video signal 114 corresponds to the video signal 100. The video signal 114 may be transmitted to a video display apparatus 17, e.g. a LCD screen.

The second band pass filter 113 receives the first audio demodulated signal 116 and generates a signal 118. Then the signal 118 is transmitted to the second demodulator 115 to recover the second audio demodulated signal 120. Finally, the second audio demodulated signal 120 is transmitted to the second amplifier. 117 for compensating the signal loss during the transmission process. The recovered audio signal 122 is therefore generated. The audio signal 122, corresponding to the original audio signal 102, may be transmitted to a loudspeaker 16.

As discussed above, the prior art communication system may only combine the video signal and the audio signal over a transmission medium. However, the data signal has to be transmitted separately through another transmission medium. In addition, a coaxial cable is used as a transmission medium. Therefore, this system not only wastes the bandwidth, but also needs extra cost for the transmission medium for data signal.

Furthermore, in order to be combined with the video signal, the audio signal has to be modulated twice. As a result, the second modulation frequency must be much higher than the first one, so the requirement of the bandwidth has to be increased. If the frequency of first modulation is decreased for this purpose, the video signal and the audio signal will interfere with each other and therefore the transmission quality is poor.

### SUMMARY OF THE INVENTION

In view of the shortcomings of the prior art, the present invention digitalizes audio signal, and then encodes and modulates the digital audio signal with data signal. The modulated signal is then combined with a modulated video signal by an adder and then the resulting signal is transmitted through an optic fiber. Therefore, the present invention may transmit the data signal, the video signal, and the audio signal simultaneously over a long distance. In addition, the present invention may also perform the remote control function by simultaneously transmitting the data signal through the optic fiber.

The signal combination apparatus includes a first modulator, a signal processor and an adder. The first modulator is configured to modulate the video signal to generate a first signal. The signal processor is configured to encode and modulate the audio signal and the data signal to generate a second signal. The adder is configure to make addition operation of the first signal and the second signal to generate a transmission signal which includes the messages of the described video signal, audio signal and data signal. The signal combination apparatus of the present invention is configured to use an optic fiber to transmit the transmission signal.

The signal processor further includes an encoder and a second modulator. The encoder is configured to encode the audio signal and the data signal to generate a third signal. The second modulator is configured to modulate the third signal to generate the described second signal.

The present invention further provides a communication system for transmitting video signal, audio signal and data signal simultaneously. The communication system includes an optic fiber module, a signal combination apparatus and a signal receiving apparatus. The optic fiber module includes an optic fiber and a photoelectric conversion transceiver apparatus, and furthermore the optic fiber connects to the transmitter of the photoelectric conversion transceiver apparatus and connects to the receiver of the photoelectric conversion transceiver apparatus respectively. The signal combination apparatus is configured for combining the video signal, the audio signal and the data signal. Except for the described elements, the signal combination apparatus further includes an image capture device and a voice receiver. The image capture device is configured to capture an image to generate video signal of the image and transmit the video signal to the first modulator. The voice receiver is configured to receive a voice to generate audio signal and transmit the audio signal to the encoder.

The signal receiving apparatus of the communication system, which includes two band pass filters, two deniodulators and a decoder, is configured to recover the video signal, audio signal and data signal.

The present invention also provides a communication system for transmitting video signal, audio signal and data signal simultaneously through an optic fiber. The communication system digitalizes the audio signal, and then encodes and modulates the audio signal with the data signal. The modulated signal is then combined with the video signal to generate a transmission signal by an adder.

### BRIEF DESCRIPTION OF THE DRAWINGS

FIG. 1 illustrates a block diagram of a prior art communication system;

FIG. 2 illustrates a block diagram of a signal combination apparatus in accordance with the present invention;

FIG. 3 illustrates a block diagram of a signal processor; and

FIG. 4 illustrates a block diagram of a communication system in accordance with the present invention.

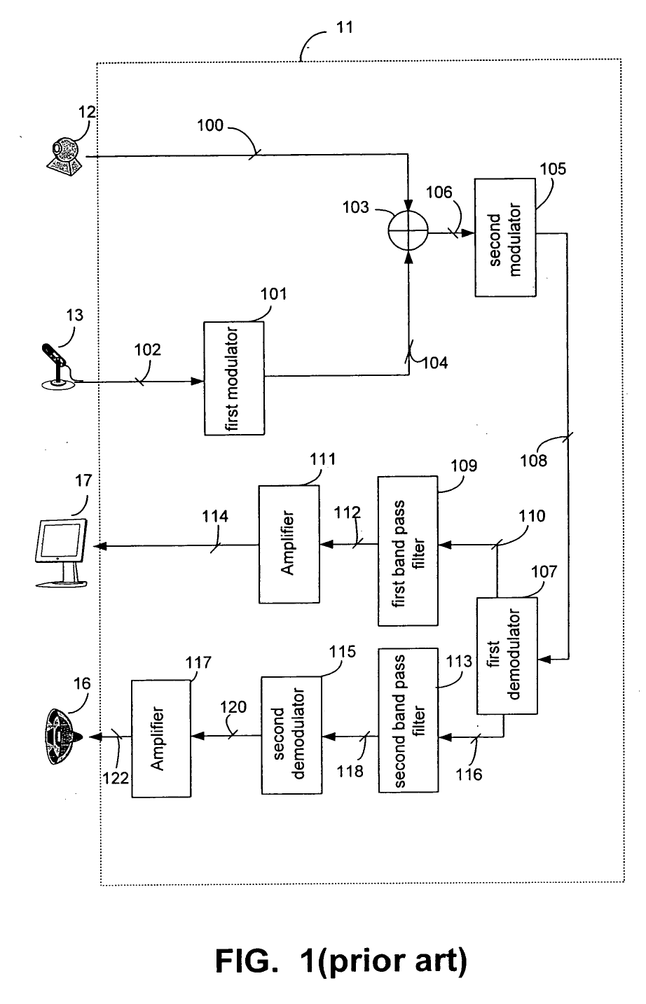

### DETAILED DESCRIPTION OF THE INVENTION

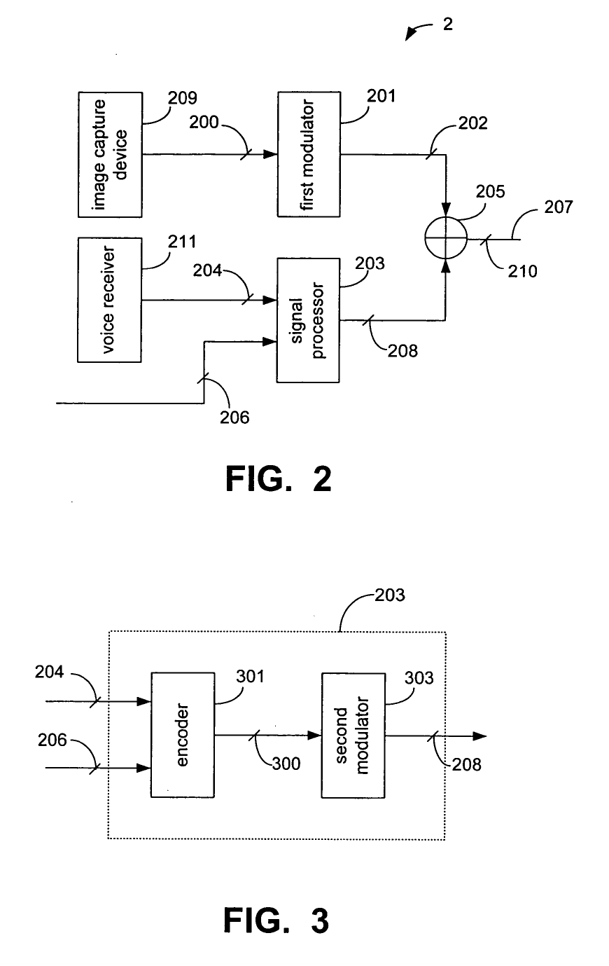

The present invention provides a signal combination apparatus for combining video signal, audio signal and data signal. In one embodiment of the present invention, with reference to FIG. 2, the signal combination apparatus 2 includes a first modulator 201, a signal processor 203 and an adder 205. The first modulator 201 is configured to modulate a video signal 200 by using a signal of the first frequency as a carrier wave to generate a first signal 202. The signal processor 203 receives an audio signal 204 and a data signal 206, and then encodes and modulates these signals to generate a second signal 208. The adder 205 receives the first signal 202 and the second signal 208, and then makes addition operation of these signals to generate a transmission signal 210. The transmission signal 210 is transmitted by an optic fiber 207.

The signal combination apparatus 2 further includes an image capture device 209 configured to capture image to generate the video signal 200 of the image. The signal combination apparatus 2 further includes a voice receiver 211 configured to receive voice to generate the audio signal 204.

The data signal 206 is transmitted from a data generation apparatus which is not included in the signal combination apparatus 2. For example, a computer transmits the data signal 206 to the signal processor 203 through a RS232 transmission line.

The signal processor 203, as illustrated in FIG. 3, includes an encoder 301 and a second modulator 303. The encoder 301 is configured to encode the audio signal 204 and the data signal 206 to generate a third signal 300. The method of encoding is not limited to any known or unknown types. The second modulator 303 is configured to modulate the third signal 300 by using a signal of the second frequency to generate the second signal 208.

It should be noted that, in this embodiment, the first modulator 201 and the second modulator 303 respectively modulates the video signal 200 and the third signal 300 by frequency modulation (FM). Accordingly, the signal combination apparatus 2 may only modulate the video signal 200 and the third signal 300 respectively and therefore the bandwidth consumption can be reduced.

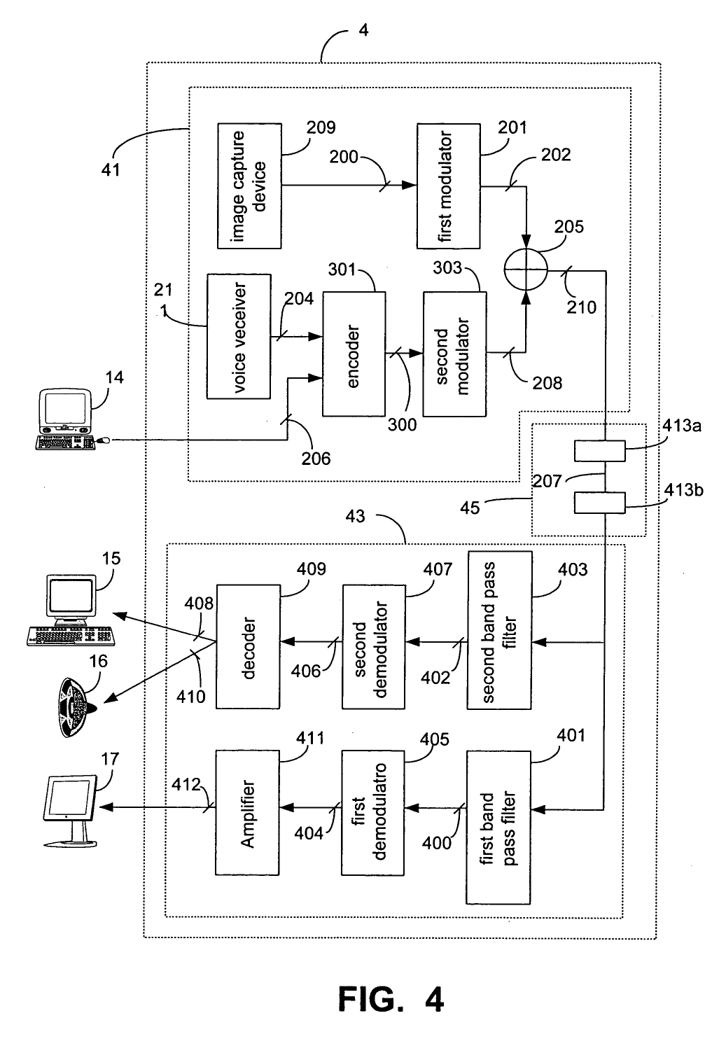

In accordance with the above described signal combination apparatus, the present invention further provides a communication system for transmitting the video signal, the audio signal and the data signal simultaneously. FIG. 4 shows an embodiment of the communication system in the present invention. With reference to FIG. 4, the communication system 4 includes an optic fiber module 45, a signal combination apparatus 41 and a signal receiving apparatus 43. The optic fiber module 45, which is configured to transmit signal from the signal combination apparatus 41 to the signal receiving apparatus 43, includes an optic fiber 207 and a photoelectric conversion transceiver apparatus 413 (including a transmitter 413a and a receiver 413b). The optic fiber 207 connects the transmitter 413a with the receiver 413b. The signal combination apparatus 41, which connects with the transmitter 413a of the photoelectric conversion transceiver apparatus 413, is configured for combining the video signal, the audio signal and the data signal. The operations of the elements in FIG. 4 are similar to those in FIG. 2 and FIG. 3.

The signal receiving apparatus 43, which includes a first band pass filter 401, a second band pass filter 403, a first demodulator 405, a second demodulator 407 and a decoder 409, connects with the receiver 413b to receive the transmission signal 210, and then recovers the video signal 200, the audio signal 204 and the data signal 206. The first band pass filter 401 filters all signals except for the signal of the first frequency, and the first signal 202 is therefore allowed to recover. Accordingly, the output of the first band pass filter 401, i.e. signal 400, corresponds to the first signal 202 of the signal combination apparatus 41. The first demodulator 405 receives and demodulates the signal 400 to recover the video signal 200. Therefore, the output of the first demodulator 405, i.e. signal 404, corresponds to the video signal 200. The embodiment further includes an amplifier 411 configured to amplify the signal 404 to generate an amplified signal 412, and then transmit the signal 412 to a video display apparatus 17.

Only the signal of the second frequency can pass through the second band pass filter 403, and the second signal 208 is therefore allowed to recover. Accordingly, the output of the second band pass filter 403, i.e. signal 402, corresponds to the second signal 208 of the signal combination apparatus 41. The second demodulator 407 receives and demodulates the signal 402 to recover the third signal 300. Therefore, the output of the second demodulator 407, i.e. signal 406, corresponds to the third signal 300. The decoder 409 receives and decodes the signal 406 to recover the audio signal 204 and the data signal 206. Therefore, the outputs of the decoder 409, i.e. signal 410 and signal 408, correspond to the audio signal 204 and the data signal 206 respectively. The communication system 4 further transmits the signal 410 to a speaker system 16 and transmits the signal 408 to a data receiving apparatus 15.

As described herein, the communication system of the present invention may transmit the video signal, the audio signal and the data signal simultaneously, and the bandwidth consumption may be reduced because each signal is modulated once. Furthermore, the communication system also combines an image capture device and a voice receiver for integrating the functions of capturing the video signal of the image and the audio signal. Moreover, the communication system is configured to use an optic fiber module as a communication medium, and consequently has advantages of low signal loss, long-distance transmission and low maintenance cost.

Although the specific embodiments of the present invention have been illustrated and described, it is to be understood that the invention is not limited to those embodiments. One skilled in the art may make various modifications without departing from the scope or spirit of the invention.

1. An apparatus for combining a video signal, an audio signal and a data signal, said apparatus comprising:
a first modulator configured to modulate said video signal to generate a first signal;
a signal processor configured to encode said audio signal and said data signal to generate a second signal; and
an adder configured to make addition operation of said first signal and said second signal to generate a transmission signal;
wherein said apparatus transmits said transmission signal via an optic fiber.

2. The apparatus of claim 1, further comprising an image capture device configured to capture an image to generate said video signal.

3. The apparatus of claim 1, further comprising a voice receiver configured to receive a voice to generate said audio signal.

4. The apparatus of claim 1, wherein said signal processor further comprises:
an encode configured to encode said audio signal and said data signal to generate a third signal; and
a second modulator configured to modulate said third signal to generate said second signal.

5. The apparatus of claim 1, wherein said first modulator modulates said video signal by frequency modulation.

6. A communication system for transmitting a video signal, an audio signal, and a data signal simultaneously, said communication system comprising:
an optic fiber module comprising an optic fiber and a photoelectric conversion transceiver apparatus, said photoelectric conversion transceiver apparatus having a transmitter and a receiver, said optic fiber connecting said transmitter with said receiver; and
a apparatus connecting with said transmitter of said photoelectric conversion transceiver apparatus, said apparatus is configured to combine said video signal, said audio signal and said data signal, said apparatus comprising:
an image capture device configured to capture an image to generate said video signal;
a voice receiver configured to receive a voice to generate said audio signal;
a first modulator configured to modulate said video signal to generate a first signal;
an encoder configured to encode said audio signal and said data signal to generate a third signal;
a second modulator configured to modulate said third signal to generate said second signal; and
an adder configured to make addition operation of said first signal and said second signal to generate a transmission signal.

7. The communication system of claim 6, wherein said first modulator and said second modulator modulate said video signal and said third signal respectively by frequency modulation.

8. The communication system of claim 6,wherein said communication system further comprises a signal receiving apparatus connected to said receiver of said photoelectric conversion transceiver apparatus, said signal receiving apparatus comprising:
a first band pass filter configured to filter said first signal;
a second band pass filter configured to filter said second signal;
a first demodulator configured to demodulate said first signal to recover said video signal;
a second demodulator configured to demodulate said second signal to recover said third signal; and
a decoder configured to decode said third signal to recover said audio signal and said data signal.
